(19) United States
(12) Patent Application Publication
(10) Pub. No.: US 2011/0199260 A1
(43) Pub. Date: Aug. 18, 2011

(54) METHOD AND SYSTEM FOR DETERMINING A LOCATION OF A CELLULAR BASE STATION UTILIZING MOBILE GNSS VELOCITY AND CORRESPONDING CELLULAR DOPPLER

(76) Inventors: David Garrett, Tustin, CA (US); Charles Abraham, Los Gatos, CA (US); Mark Buer, Gilbert, AZ (US); Jeyhan Karaoguz, Irvine, CA (US); David Albert Lundgren, Mill Valley, CA (US); David Murray, Mission Viejo, CA (US); Frank van Diggelen, San Jose, CA (US)

(21) Appl. No.: 12/748,142

(22) Filed: Mar. 26, 2010

Related U.S. Application Data
(60) Provisional application No. 61/304,100, filed on Feb. 12, 2010.

(51) Int. Cl. G01S 19/52; G01S 5/10

(52) U.S. Cl. 342/357.35; 342/357.78

(57) ABSTRACT

A GNSS enabled mobile device concurrently receives GNSS signals from GNSS satellites and transmissions from a cellular base station. GNSS-based velocities and GNSS locations are determined for the GNSS enabled mobile device utilizing the received GNSS signals. A cellular Doppler is measured on the cellular base station. A location of the cellular base station is determined based on the determined GNSS-based velocity and corresponding cellular Doppler measurements. The cellular base station may be located by the GNSS enabled mobile device and/or by a remote location server. In this regard, the remote location server may determine the location for the cellular base station utilizing GNSS velocities and corresponding cellular Doppler measurements received from plural GNSS enabled mobile devices in a coverage area of the cellular base station. The determined location of the cellular base station is used to refine GNSS locations of the plurality of GNSS enabled mobile devices when needed.

### CROSS-REFERENCE TO RELATED APPLICATIONS/INCORPORATION BY REFERENCE

This patent application makes reference to, claims priority to and claims the benefit from U.S. Provisional Patent Application Ser. No. 61/304,100 filed on Feb. 12, 2010.

This patent application makes reference to:
U.S. Application Ser. No. 61/312,970 filed on Mar. 11, 2010,
U.S. Application Ser. No. 61/303,975 filed on Feb. 12, 2010,
U.S. Application Ser. No. 61/305,758 filed on Feb. 18, 2010,
U.S. application Ser. No. ______ (Attorney Docket No. 21010US02) filed on even date herewith,
U.S. application Ser. No. ______ (Attorney Docket No. 21015US02) filed on even date herewith, and
U.S. application Ser. No. ______ (Attorney Docket No. 21026US02) filed on even date herewith.

Each of the above stated applications is hereby incorporated herein by reference in its entirety.

### FIELD OF THE INVENTION

Certain embodiments of the invention relate to communication systems. More specifically, certain embodiments of the invention relate to a method and system for determining a location of a cellular base station utilizing mobile GNSS velocity and corresponding cellular Doppler.

### BACKGROUND OF THE INVENTION

Location-based services (LBS) are emerging as a new type of value-added service provided by mobile communication network. LBS are mobile services in which the user location information is used in order to enable various LBS applications such as, for example, enhanced 911 (E-911), location-based 411, location-based messaging and/or location-based friend finding services. A location of a mobile device may be determined in different ways such as, for example, using network-based technology, using terminal-based technology, and/or hybrid technology, which is a combination of the former technologies. Many positioning technologies such as, for example, Time of Arrival (TOA), Observed Time Difference of Arrival (OTDOA), Enhanced Observed Time Difference (E-OTD) as well as the Global navigation satellite-based systems (GNSS) such as Global Positioning System (GPS), Global Navigation Satellite System (GLONASS), Galileo, and/or Assisted-GNSS (A-GNSS), may be utilized to estimate the location (latitude and longitude) of the mobile device and convert it into a meaningful X, Y coordinate for LBS applications. A-GNSS technology combines satellite positioning and communication networks such as mobile networks to reach performance levels allowing the wide deployment of Location-Based Services.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A method and/or system for determining a location of a cellular base station utilizing mobile GNSS velocity and corresponding cellular Doppler, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a diagram illustrating an exemplary communication system that is operable to locate a cellular base station utilizing cellular Doppler measurements and corresponding GNSS-based velocities, in accordance with an embodiment of the invention.

FIG. 2 is a block diagram illustrating an exemplary mobile device that is operable to provide GNSS-based velocities and corresponding cellular Doppler measurements for locating a cellular base station, in accordance with an embodiment of the invention.

FIG. 3 is a block diagram illustrating an exemplary location server that is operable to determine the location of a cellular base station utilizing GNSS-based velocities and corresponding cellular Doppler measurements, in accordance with an embodiment of the invention.

FIG. 4 is a flow chart illustrating an exemplary procedure that is utilized by a location server to determine a location of a cellular base station utilizing GNSS-based velocities and corresponding cellular Doppler measurements, in accordance with an embodiment of the invention.

FIG. 5 is a flow chart illustrating an exemplary procedure that is utilized by a GNSS enabled mobile device to refine a GNSS location from a known base station location utilizing GNSS-based velocities and corresponding cellular Doppler measurements, in accordance with an embodiment of the invention.

FIG. 6 is a flow chart illustrating an exemplary procedure that is utilized by a GNSS enabled mobile device to locate a cellular base station utilizing GNSS-based velocities and corresponding cellular Doppler measurements, in accordance with an embodiment of the invention.

### DETAILED DESCRIPTION OF THE INVENTION

Certain embodiments of the invention may be found in a method and system for determining a location of a cellular base station utilizing mobile GNSS velocity and corresponding cellular Doppler. In various embodiments of the invention, a GNSS enabled mobile device is operable to concurrently receive GNSS satellite signals from a plurality of GNSS satellites and data transmissions from a cellular base station. The GNSS enabled mobile device utilizes the received GNSS signals to determine a GNSS-based velocity and a GNSS location for the GNSS enabled mobile device. A cellular Doppler, which corresponds to the determined GNSS-based velocity GNSS enabled mobile device, may be measured on the received data transmissions from the cellular base station. A location of the cellular base station may be determined based on the determined GNSS-based velocity and corresponding cellular Doppler measurement. In instances where the cellular base station is located via the location server, the GNSS enabled mobile device may location stamp the determined GNSS-based velocity of the GNSS enabled mobile device and the corresponding cellular Doppler measurement utilizing the determined GNSS location of the GNSS enabled mobile device for transmission to the location server to build a reference database. The location server may receive GNSS velocities and corresponding cellular Doppler measurements from a plurality of GNSS enabled mobile device in a coverage area of the cellular base station. The remote location server may be operable to fit the received plurality of GNSS velocities and corresponding cellular Doppler measurements to a velocity-Doppler model over certain Doppler angles. The location of the cellular base station may be determined based on the resulting fitted plurality of GNSS velocities and corresponding cellular Doppler measurements, and locations of GNSS enabled mobile device in the coverage area of the cellular base station. In instances where the cellular base station is initially located via the GNSS enabled mobile device, the GNSS enabled mobile device may determine a location for the cellular base station utilizing GNSS-based velocities, corresponding cellular Doppler measurements and its own known GNSS locations. The GNSS enabled mobile device may calculate the location for the cellular base station via simultaneously solving two or more non-linear equations. The determined location of the cellular base station may be stored, for example, to refine GNSS locations of the GNSS enabled mobile device.

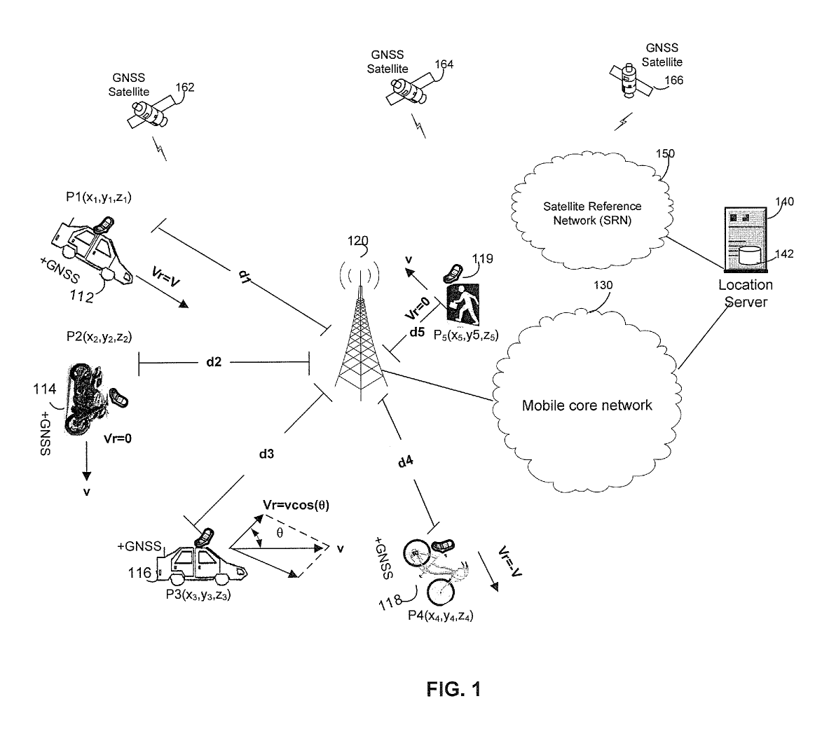

FIG. 1 is a diagram illustrating an exemplary communication system that is operable to locate a cellular base station utilizing cellular Doppler measurements and corresponding GNSS-based velocities, in accordance with an embodiment of the invention. Referring to FIG. 1, there is shown a communication system 100. The communication system 100 comprises a plurality of Global Navigation Satellite Systems (GNSS) enabled mobile devices, of which GNSS enabled mobile devices 112-119 at positions P1-P5 are illustrated, a cellular base station 120, a mobile core network 130, a location server 140 comprising a reference database 142, a satellite reference network (SRN) 150 and a plurality of GNSS satellites, of which GNSS satellites 162-166 are illustrated.

A GNSS enabled mobile device such as the GNSS enabled mobile device 112 may comprise suitable logic, circuitry, interfaces and/or code that are operable to concurrently receive satellite broadcast signals from GNSS satellites in view such as, for example, the GNSS satellites 162-166, and radio signals over radio channels between the GNSS enabled mobile device 112 and the cellular base station 120. The GNSS enabled mobile device 112 may take various GNSS measurements such as pseudorange and/or carrier phase on the received GNSS signals to calculate navigation information such as, for example, mobile GNSS position and/or mobile velocity. The received radio signals from the cellular base station 120 may comprise data transmissions of services provided by the mobile core network 130. The quality of the data transmissions received may vary depending on the radio channels utilized. In instances where the GNSS enabled mobile device 112 is moving in a coverage area of the cellular base station 120, the GNSS enabled mobile device 112 may vary its speed as well as the moving direction and/or the distance relative to the cellular base station 120. In this regard, the radio channels between the GNSS enabled mobile device 112 and the cellular base station 120 may become time-variant resulting in fading effects on corresponding data transmissions. Due to the mobility of the GNSS enabled mobile device 112, a cellular Doppler shift of the data transmissions over the radio channels may arise from a relative motion between the GNSS enabled mobile device 112 and the cellular base station 120. A cellular Doppler shift may lead to frequency dispersion and time-selective fading on the radio channels causing interferences and degradation of signal quality. In this regard, the GNSS enabled mobile device 112 may be configured to measure or track cellular Doppler shift of data transmissions from the cellular base station 120 so as to optimally tuning system parameters such as, for example, a hysteresis and averaging window size utilized for a handover decision, to changing channel conditions.

A cellular Doppler shift of data transmissions from the cellular base station 120 to the GNSS enabled mobile device 116 is proportional to a velocity of the GNSS enabled mobile device 116. For example, assume that the GNSS enabled mobile device 116 is moving with a velocity v in a direction of an angle θ relative to the cellular base station 120, a relative mobile velocity, vᵣ, between the GNSS enabled mobile device 116 and the cellular base station 120 may be calculated through vᵣ=v cos(θ). It is the relative mobile velocity, vᵣ, that leads to a Doppler shift, f_{d}, on the data transmissions from the cellular base station 120. More specifically, the Doppler shift, f_{d}, may be expressed as

$${f}_{d} = \frac{{\overline{v}}_{r}}{λ} = \frac{\overline{v} cos ( θ )}{λ} ,$$

where λ is the wavelength of the received data transmissions. The angle θ may also be referred to a Doppler angle of the Doppler shift, f_{d}.

The GNSS enabled mobile device 112 may be operable to derive its own velocity v utilizing GNSS signals received from visible GNSS satellites and/or cellular radio signals received from the cellular base station 120. A velocity derived from the received GNSS signals is referred to a GNSS-based velocity. A velocity derived from the received cellular radio signals is referred to a cellular-based velocity. In this regard, in instances when a cellular-based velocity and a GNSS-based velocity are available or possible for the GNSS enabled mobile device 116, the GNSS-based velocity may be selected for use whenever needed. In this regard, the GNSS enabled mobile device 116 may be configured to track or calculate GNSS-based velocities at different locations such as the locations P1-P5. For each calculated GNSS-based velocity, the GNSS enabled mobile device 116 may measure a corresponding cellular Doppler on data transmissions received from the cellular base station 120.

In various exemplary embodiments of the invention, the cellular base station 120 may be located via the location server 140. In this regard, the GNSS enabled mobile device 112 may be configured to stamp calculated GNSS velocities and corresponding cellular Doppler measurements utilizing corresponding locations such as the locations P1-P5. The resulting location-stamped GNSS velocities and cellular Doppler measurements may be transmitted to the location server 140. In this regard, the transmitted location-stamped GNSS velocities and cellular Doppler measurements may be utilized by the location server 140 to determine the location of the cellular base station 120. For example, the transmitted location-stamped GNSS velocities and cellular Doppler measurements may be fitted by the location server 140 to a velocity-Doppler model of

$${f}_{d} = \frac{{\overline{v}}_{r}}{λ} = \frac{\overline{v} cos ( θ )}{λ}$$

over a certain Doppler angle θ. Depending on device capabilities, the GNSS enabled mobile device 112 may be operable to communicate with the mobile core network 130 using, for example, CDMA, GSM, UMTS, and/or LTE access technologies.

In various exemplary embodiments of the invention, in instances where the location of the cellular base station 120 is known and accurate, a GNSS location of the GNSS enabled mobile device 112 may be refined or located from the known location of the cellular base station 120. For example, in instances where the GNSS enabled mobile device 112 at a determined GNSS location is moving with a velocity of v, the orientation of the GNSS enabled mobile device 112 may be identified or determined from a corresponding cellular Doppler measurement at the determined GNSS location. The GNSS enabled mobile device 112 may derive a relative velocity, vᵣ, with respect to the cellular base station 120 based on the determined orientation. The GNSS enabled mobile device 112 may be located utilizing the derived relative velocity, vᵣ, from the known location cellular base station 120. The resulting location of the GNSS enabled mobile device 112 may be used to refine the determined GNSS location of the GNSS enabled mobile device 112. The refined GNSS location of the GNSS enabled mobile device 112 may be transmitted to the location server 140 to build the reference database 142.

In various exemplary embodiments of the invention, the cellular base station 120 may be initially located via a plurality of GNSS enabled mobile devices. Among mobile devices located in the same altitude as the cellular base station 120, a single mobile device such as the GNSS enabled mobile device 112 at known locations (xᵢ,yᵢ), iε[1, 2, . . . ] may be operable to utilize GNSS-based velocities and corresponding cellular Doppler measurements to accurately locate the cellular base station 120, (x_{BS},y_{BS}). For example, in instances where the GNSS enabled mobile device 112 at the location (xᵢ,yᵢ) is moving with a velocity of vᵢ in a direction of an angle, θᵢ, relative to the cellular base station 120, the location (x_{BS},y_{BS}) for the cellular base station 120 may be calculated through

$${θ}_{i} = {tan}^{- 1} ( \frac{{x}_{i} - {x}_{BS}}{{y}_{i} - {y}_{BS}} ) .$$

In instances where the cellular base station 120 is operating with a perfect clock, corresponding cellular Doppler measurements to the velocity of vᵢ may be expressed as

$${f}_{d , i} = \frac{{\overline{v}}_{i} cos ( {θ}_{i} )}{λ} .$$

Accordingly, we have

$${θ}_{i} = {cos}^{- 1} ( \frac{{f}_{d , i} λ}{{v}_{i}} ) .$$

In this regard, the GNSS enabled mobile device 112 at the location (xᵢ,yᵢ) may be operable to determine (x_{BS},y_{BS}) for the cellular base station 120 by solving an non-linear equation of

$${cos}^{- 1} ( \frac{{f}_{d , i} λ}{{\overline{v}}_{i}} ) = {tan}^{- 1} ( \frac{{x}_{i} - {x}_{BS}}{{y}_{i} - {y}_{BS}} ) .$$

At least 2 different non-linear equations

$${cos}^{- 1} ( \frac{{f}_{d , i} λ}{{\overline{v}}_{i}} ) = {tan}^{- 1} ( \frac{{x}_{i} - {x}_{BS}}{{y}_{i} - {y}_{BS}} ) ,$$

i=1, 2, need to be solved simultaneously to determine or calculate (x_{BS},y_{BS}) for the cellular base station 120.

In instances where the cellular base station 120 is operating with an imperfect clock, corresponding cellular Doppler measurements corresponding to the velocity of vᵢ may be influenced by a frequency offset of the cellular base station 120, fₑ. In this regard, the cellular Doppler measurements corresponding to the velocity of vᵢ may be expressed as

$${f}_{d , i} = \frac{{\overline{v}}_{i} cos ( {θ}_{i} )}{λ} + {f}_{e} .$$

Accordingly, the relative direction between the GNSS enabled mobile device 112 and the cellular base station 120 may be expressed as

$${θ}_{i} = {cos}^{- 1} ( \frac{( {f}_{d , i} - {f}_{e} ) λ}{{v}_{i}} ) .$$

In this regard, the GNSS enabled mobile device 112 at the location (xᵢ,yᵢ) may be operable to determine (x_{BS},y_{BS}) for the cellular base station 120 by solving an non-linear equation of

$${cos}^{- 1} ( \frac{( {f}_{d , i} - {f}_{e} ) λ}{{\overline{v}}_{i}} ) = {tan}^{- 1} ( \frac{{x}_{i} - {x}_{BS}}{{y}_{i} - {y}_{BS}} ) .$$

At least 3 different non-linear equations

$${cos}^{- 1} ( \frac{( {f}_{d , i} - {f}_{e} ) λ}{{\overline{v}}_{i}} ) = {tan}^{- 1} ( \frac{{x}_{i} - {x}_{BS}}{{y}_{i} - {y}_{BS}} ) ,$$

i=1, 2, 3, need to be solved simultaneously so as to determine or calculate (x_{BS},y_{BS}) for the cellular base station 120.

Various methods such as, for example, the Hirota Bilinear method and the Runge-Kutta method, may be utilized to solve the non-linear equations

$${cos}^{- 1} ( \frac{{f}_{d , i} λ}{{\overline{v}}_{i}} ) = {tan}^{- 1} ( \frac{{x}_{i} - {x}_{BS}}{{y}_{i} - {y}_{BS}} ) or {cos}^{- 1} ( \frac{( {f}_{d , i} - {f}_{e} ) λ}{{\overline{v}}_{i}} ) = {tan}^{- 1} ( \frac{{x}_{i} - {x}_{BS}}{{y}_{i} - {y}_{BS}} )$$

for (x_{BS},y_{BS}). The determined location (x_{BS},y_{BS}) for the cellular base station 120 may be utilized by the GNSS enabled mobile device 112 to refine its own location whenever needed. The cellular base station 120 may also be operable to communicate the determined location (x_{BS},y_{BS}) for the cellular base station 120 to the location server 140 to build the reference database 142.

A cellular base station such as the cellular base station 120 may comprise suitable logic, circuitry, interfaces and/or code that are operable to manage and schedule communication resources in an uplink direction and/or downlink direction to users of various mobile devices such as the GNSS enabled mobile devices 112-119. The cellular base station 120 may be operable to communicate radio frequency signals with the GNSS enabled mobile devices 112-119 using air interface protocols specified in, for example, CDMA, GSM, UMTS, and/or LTE radio access networks. The communicated radio signals may comprise data transmissions of various services such as a LBS provided by the mobile core network 130. In this regard, location information such as the location of the cellular base station 120 may be required for LBS applications such as location based access control. The location of the cellular base station 120 may be provided by the location server 140. In various exemplary embodiments of the invention, the location for the cellular base station 120 may be initially determined or calculated by various mobile devices, such as the GNSS enabled mobile device 112, at a known location utilizing GNSS-based velocities and corresponding cellular Doppler measurements. Depending on system configuration, the location for the cellular base station 120 may also be determined by the location server 140 using GNSS-based velocities and corresponding cellular Doppler measurements provided by a plurality of GNSS enabled mobile devices within the coverage area of the cellular base station 120. The determined location of the cellular base station 120 may be utilized to support various applications such as, for example, the determined location of the cellular base station 120 may be utilized to refine GNSS locations of GNSS enabled mobile devices 112-119.

The mobile core network 130 may comprise suitable logic, circuitry, interfaces and/or code that are operable to interface various access networks such as, for example, a CDMA network, a UMTS network and/or a WiMAX network, with external data networks such as packet data networks (PDNs). The mobile core network 130 may be operable to provide various data services, which are provided by external data networks, to users such as, for example, the GNSS enabled mobile devices 112-119. In instances where a LBS application is provided to a user of the GNSS enabled mobile device 112, the mobile core network 130 may communicate with the location server 140 for location information required for the LBS application.

The location server 140 may comprise suitable logic, circuitry, interfaces and/or code that are operable to access the satellite reference network (SRN) 150 to collect GNSS satellite data by tracking GNSS constellations through the SRN 150. The location server 140 may be operable to utilize the collected GNSS satellite data to generate GNSS assistance data (A-GNSS data) comprising, for example, ephemeris data, LTO data, reference positions and/or time information. The location server 150 may be operable to collect and/or retrieve location information of interest from a plurality of users. For example, the location server 140 may track location information of the cellular base station 120 from a plurality of mobile devices such as the GNSS enabled mobile devices 112-119 in the coverage area of the cellular base station 120.

In various exemplary embodiments of the invention, the location server 140 may be operable to receive, from a plurality of GNSS enabled mobile devices, location-stamped GNSS-based velocities and corresponding cellular Doppler measurements. The received location-stamped GNSS-based velocities and corresponding cellular Doppler measurements may be provided by GNSS enabled mobile devices at different locations in the coverage area of the cellular base station 120. The received location-stamped GNSS-based velocities and corresponding cellular Doppler measurements may be utilized to locate the cellular base station 120. For example, the location server 140 may be configured to fit the received location-stamped GNSS velocities and cellular Doppler measurements to a velocity-Doppler model of

$${f}_{d} = \frac{{\overline{v}}_{r}}{λ} = \frac{\overline{v} cos ( θ )}{λ}$$

over a certain Doppler angle of θ.

A Doppler angle, θ, of a received cellular Doppler measurement from the GNSS enabled mobile device 112 indicates that the GNSS enabled mobile device 112 is moving in a direction with an angle equal to θ relative to a corresponding transmission path to the GNSS enabled mobile device 112 from the cellular base station 120.

In instances where a received cellular Doppler measurement, f_{d}, from, for example, the GNSS enabled mobile device 114, comprises a Doppler angle of θ, where

$$θ = ( 2 k + 1 ) \frac{π}{2} , k ∈ [ 0 , \pm 1 , \pm 2 , … ] ,$$

the location server 140 may determine that the GNSS enabled mobile device 114 is moving in a direction perpendicular to a corresponding transmission path from the cellular base station 120. In other words, the location server 140 considers that the GNSS enabled mobile device 114 is not moving to the cellular base station 120.

In instances where a received cellular Doppler measurement, f_{d}, from, for example, the GNSS enabled mobile device 112, comprises a Doppler angle of θ equal to 2kπ, kε[0, ±1, ±2, . . . ], the location server 140 may determine that the GNSS enabled mobile device 112 is moving straight to the cellular base station 120. In this circumstance, the GNSS enabled mobile device 112 has a maximized Doppler shift of data transmissions to the GNSS enabled mobile device 112 from the cellular base station 120.

In instances where a received cellular Doppler measurement, f_{d}, from, for example, the GNSS enabled mobile device 118 comprises a Doppler angle of θ equal to (2k+1)π, kε[0, ±1, ±2, . . . ], the location server 140 may determine that the GNSS enabled mobile device 118 is moving straight in the opposite direction to the cellular base station 120.

The location server 140 may be operable to determine a location of the cellular base station 120 based on locations of the GNSS enabled mobile devices such as the GNSS enabled mobile devices 112-119, and the fitted GNSS velocities and corresponding cellular Doppler measurements. The determined location for the cellular base station 120 may be stored into the reference database 142, where it may be shared among a plurality of users. For example, the determined location of the cellular base station 120 may be utilized to refine GNSS locations of GNSS enabled mobile devices 112-119.

In various exemplary embodiments of the invention, the location server 140 may also be operable to receive locations for the cellular base station 120 that are initially projected or estimated from a plurality of GNSS enabled mobile devices such as the GNSS enabled mobile devices 112-119. The received projected locations for the cellular base station 120 are determined or calculated by the GNSS enabled mobile devices utilizing GNSS-based velocities and corresponding cellular Doppler measurements. The location server 140 may determine a location for the cellular base station 120 based on the received locations initially projected from the plurality of GNSS enabled mobile devices. The determined location for the cellular base station 120 may be stored into the reference database 142, where it may be shared among a plurality of communication devices such as the GNSS enabled mobile devices 112-119 to improve LBS performance.

The SRN 150 may comprise suitable logic, circuitry, interfaces and/or code that are operable to acquire, collect and/or distribute data for GNSS satellites on a continuous basis. The SRN 150 may comprise a plurality of GNSS reference tracking stations located around the world to provide constant A-GNSS coverage in both a home network and/or any visited network.

The GNSS satellites 162-166 may comprise suitable logic, circuitry, interfaces and/or code that may be operable to generate and broadcast satellite navigational information. The broadcast satellite navigational information may be collected by the SRN 150 to be utilized by the location server 140 to enhance LBS performance. The GNSS satellites 162-166 may comprise GPS, Galileo, and/or GLONASS satellites.

In an exemplary operation, GNSS enabled mobile devices in a coverage area of the cellular base station 120 may be operable to receive GNSS signals from visible GNSS satellites such as the GNSS satellites 162-166. Each GNSS enabled mobile device such as the GNSS enabled mobile device 112 may be operable to utilize the received GNSS signals to generate or calculate its own GNSS-based velocity. The GNSS enabled mobile device 112 may also receive data transmissions from the cellular base station 120. In instances where the GNSS enabled mobile device 112 is moving in the coverage area of the cellular base station 120, a cellular Doppler shift may arise on the data transmissions from the cellular base station 120. The GNSS enabled mobile device 112 may measure a corresponding cellular Doppler shift of the data transmissions from the cellular base station 120 for the generated GNSS-based velocity. The GNSS enabled mobile device 112 may be operable to generate GNSS-based velocities and perform cellular Doppler measurements at different locations such as the locations P1-P5 over a period of time.

In various exemplary embodiments of the invention, the cellular base station 120 may be located via the location server 140. In this regard, the GNSS enabled mobile device 112 at a known location such as the location P1 may be operable to stamp a calculated GNSS-based velocity and a corresponding cellular Doppler measurement utilizing the known location, namely, the location P1. The location-stamped GNSS-based velocity and cellular Doppler measurement may be transmitted by the GNSS enabled mobile device 112 to the location server 140 over the mobile core network 130. The location server 140 may track or receive GNSS velocities and corresponding cellular Doppler measurements from a plurality of users such as, for example, the GNSS enabled mobile devices 112-119. The received GNSS velocities and corresponding cellular Doppler measurements may be utilized by the location server 140 to determine the location of the cellular base station 120. For example, the location server 140 may be configured to fit the received location-stamped GNSS velocities and cellular Doppler measurements to a velocity-Doppler model of

$${f}_{d} = \frac{{\overline{v}}_{r}}{λ} = \frac{\overline{v} cos ( θ )}{λ}$$

over a certain Doppler angle, θ. The determined location of the cellular base station 120 may be stored into the reference database 142, where it may be shared among a plurality of users such as the GNSS enabled mobile devices 112-119 to refine corresponding GNSS locations.

In various exemplary embodiments of the invention, a single mobile device such as the GNSS enabled mobile device 112 at a known location may utilize GNSS-based velocities and corresponding cellular Doppler measurements to initially locate the cellular base station 120. The resulting initial location for the cellular base station 120 may be transmitted or communicated to the location server 140 to build the reference database 142. The location server 140 may determine a location of the cellular base station 120 based on initial locations from a plurality GNSS enabled mobile devices for the cellular base station 120.

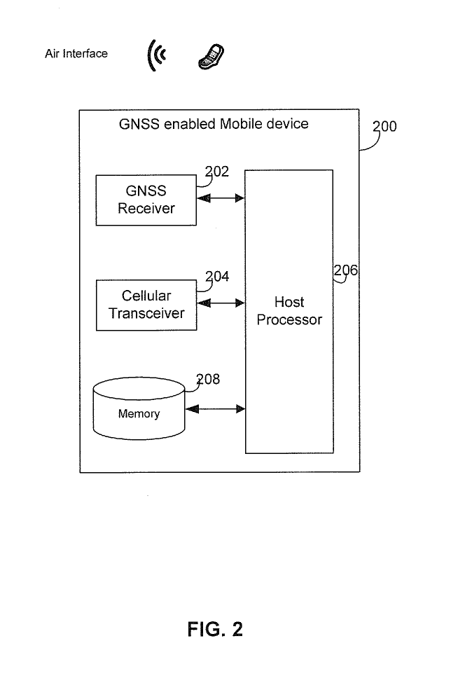

FIG. 2 is a block diagram illustrating an exemplary mobile device that is operable to provide GNSS-based velocities and corresponding cellular Doppler measurements for locating a cellular base station, in accordance with an embodiment of the invention. Referring to FIG. 2, there is shown a GNSS enabled mobile device 200. The GNSS enabled mobile device 200 comprises a GNSS receiver 202, a cellular transceiver 204, a host processor 206 and a memory 208.

The GNSS receiver 202 may comprise suitable logic, circuitry, interfaces and/or code that may be operable to detect and receive GNSS signals from a plurality of visible GNSS satellites such as the GNSS satellite 162-166. The GNSS receiver 202 may be operable to utilize the received GNSS signals to calculate navigation information such as a GNSS position and/or a GNSS-based velocity of the GNSS receiver 202. The calculated GNSS-based velocity of the GNSS receiver 202 may be provided to the host processor 206 for locating the cellular base station 120.

The cellular transceiver 204 may comprise suitable logic, circuitry, interfaces and/or code that may be operable to communicate with the cellular base station 120 using various cellular access technologies such as CDMA, GSM, UMTS and/or LTE. The cellular transceiver 204 may receive data transmissions from the cellular base station 120. The received data transmissions may comprise services provided by the mobile core network 130. In instances where the GNSS enabled mobile device 200 is moving relative to corresponding transmission paths from the cellular base station 120, the cellular transceiver 204 may be configured to track or measure a cellular Doppler shift of data transmissions from the cellular base station 120. The cellular transceiver 204 may provide the resulting cellular Doppler measurements to the host processor 206 for locating the cellular base station 120.

The host processor 206 may comprise suitable logic, circuitry, interfaces and/or code that may be operable to manage and/or control operations of associated device component units such as the GNSS receiver 202 and/or the cellular transceiver 204 depending on usages. For example, the host processor 206 may be operable to activate or deactivate one or more associated radios such as the GNSS receiver 202 and/or the cellular transceiver 204 as a needed basis to save power. The host processor 206 may be configured to coordinate the operations of the GNSS receiver 202 and the cellular transceiver 204 so as to synchronize the generation of a GNSS-based velocity and a corresponding cellular Doppler measurement.

In various exemplary embodiments of the invention, in instances where the cellular base station 120 is located via the location server 140, the host processor 206 may also be operable to location stamp the GNSS-based velocity and the corresponding cellular Doppler measurement for transmission to the location server 140 for locating the cellular base station 120.

In various exemplary embodiments of the invention, in instances where the location of the cellular base station 120 is known and accurate, the host processor 206 may be operable to refine the determined GNSS location based on the known location of the cellular base station 120, and the GNSS-based velocity and the corresponding cellular Doppler measurement.

In various embodiments of the invention, the host processor 206 may be operable to initially locate the cellular base station 120 utilizing GNSS-based velocities and corresponding cellular Doppler measurements. For example, in instances where the GNSS enabled mobile device 200 at the location (xᵢ,yᵢ) is moving with a velocity of vᵢ in a direction of an angle θᵢ, relative to the cellular base station 120 at (x_{BS},y_{BS}), the host processor 206 may calculate vᵢ utilizing GNSS signals received. Cellular Doppler measurements corresponding to the calculated GNSS-based velocity vᵢ may be carried out. The host processor 206 may be operable to calculate (x_{BS},y_{BS}) utilizing GNSS-based velocities and corresponding cellular Doppler measurements. In instances where the cellular base station 120 is operating with a perfect clock, the host processor 206 may be operable to calculate (x_{BS},y_{BS}) by solving an non-linear equation of

$${cos}^{- 1} ( \frac{{f}_{d , i} λ}{{\overline{v}}_{i}} ) = {tan}^{- 1} ( \frac{{x}_{i} - {x}_{BS}}{{y}_{i} - {y}_{BS}} ) .$$

At least 2 non-linear equations

$${cos}^{- 1} ( \frac{{f}_{d , i} λ}{{\overline{v}}_{i}} ) = {tan}^{- 1} ( \frac{{x}_{i} - {x}_{BS}}{{y}_{i} - {y}_{BS}} ) ,$$

i=1, 2, need to be solved simultaneously so as to determine or calculate (x_{BS},y_{BS}) for the cellular base station 120. In instances where the cellular base station 120 is operating with an imperfect clock, the host processor 206 may be operable to calculate (x_{BS},y_{BS}) by solving an non-linear equation of

$${cos}^{- 1} ( \frac{( {f}_{d , i} - {f}_{e} ) λ}{{\overline{v}}_{i}} ) = {tan}^{- 1} ( \frac{{x}_{i} - {x}_{BS}}{{y}_{i} - {y}_{BS}} ) .$$

At least 3 different non-linear equations

$${cos}^{- 1} ( \frac{( {f}_{d , i} - {f}_{e} ) λ}{{\overline{v}}_{i}} ) = {tan}^{- 1} ( \frac{{x}_{i} - {x}_{BS}}{{y}_{i} - {y}_{BS}} ) , i = 1 , 2 , 3 ,$$

need to be solved simultaneously so as to determine (x_{BS},y_{BS}) for the cellular base station 120.

The host processor 206 may be operable to utilize various methods such as, for example, the Hirota bilinear method and the Runge-Kutta method, to solve the non-linear equations

$${cos}^{- 1} ( \frac{{f}_{d , i} λ}{{\overline{v}}_{i}} ) = {tan}^{- 1} ( \frac{{x}_{i} - {x}_{BS}}{{y}_{i} - {y}_{BS}} ) ,$$

i=1, 2, or

$${cos}^{- 1} ( \frac{( {f}_{d , i} - {f}_{e} ) λ}{{\overline{v}}_{i}} ) = {tan}^{- 1} ( \frac{{x}_{i} - {x}_{BS}}{{y}_{i} - {y}_{BS}} ) ,$$

i=1, 2, 3, for (x_{BS},y_{BS}). The host processor 206 may utilize the determined location (x_{BS},y_{BS}) to refine its own location whenever needed. The determined or calculated (x_{BS},y_{BS}) for the cellular base station 120 may also be communicated or transmitted to the location server 140 to build the reference database 142.

The memory 208 may comprise suitable logic, circuitry, interfaces and/or code that may be operable to store information such as executable instructions and data that may be utilized by the host processor 206 and/or other device components such as, for example, the GNSS receiver 202 and the cellular transceiver 204. The memory 208 may comprise RAM, ROM, low latency nonvolatile memory such as flash memory and/or other suitable electronic data storage.

In an exemplary operation, the host processor 206 may be operable to manage and/or control operations of, for example, the GNSS receiver 202 and/or the cellular transceiver 204, depending on corresponding usages. For example, the host processor 206 may be operable to coordinate the operations of the GNSS receiver 202 and the cellular transceiver 204 to simultaneously receive GNSS signals from GNSS satellites and receive data transmissions from the cellular base station 120. The host processor 206 may be operable to synchronize the generation of GNSS-based velocities and corresponding cellular Doppler measurements. In various exemplary embodiments of the invention, the host processor 206 may be operable to locate the cellular base station 120 utilizing the GNSS-based velocities and corresponding cellular Doppler measurements. The resulting location for the cellular base station 120 may be utilized by the host processor 206 to refine the location for the GNSS enabled mobile device 200 whenever needed. The host processor 206 may also be operable to communicate the location for the cellular base station 120 to the location server 140 to refine the reference database 142. In various exemplary embodiments of the invention, the generated GNSS-based velocity and a corresponding cellular Doppler measurement may be stamped utilizing a corresponding location of the GNSS enabled mobile device 200. The location-stamped GNSS-based velocity and cellular Doppler measurement may be transmitted to the location server 140 for locating the cellular base station 120. The resulting location of the cellular base station 120 may also be utilized by the host processor 206 to refine the determined GNSS location utilizing the GNSS-based velocity and the corresponding cellular Doppler measurement.

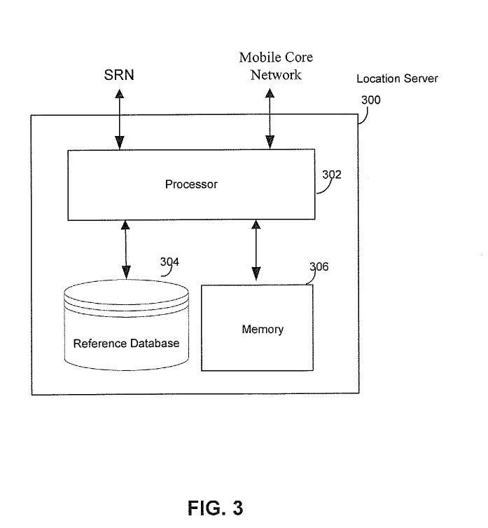

FIG. 3 is a block diagram illustrating an exemplary location server that is operable to determine the location of a cellular base station utilizing GNSS-based velocities and corresponding cellular Doppler measurements, in accordance with an embodiment of the invention. Referring to FIG. 3, there is shown a location server 300. The location server 300 may comprise a processor 302, a reference database 304 and a memory 306.

The processor 302 may comprise suitable logic, circuitry, interfaces and/or code that may be operable to manage and/or control operations of the reference database 304 and the memory 306. The processor 302 may be operable to communicate with the satellite reference network (SRN) 150 so as to collect GNSS satellite data by tracking GNSS constellations through the SRN 150. The processor 302 may utilize the collected GNSS satellite data to build the reference database 304, which may be coupled internally or externally to the location server 300. The processor 302 may be operable to retrieve location information from users such as the GNSS enabled mobile devices 112-119. The processor 302 may also track or collect information that may be utilized for locating an object of interest such as the cellular base station 120.

In various exemplary embodiments of the invention, the cellular base station 120 is located via the location server 300. The processor 302 may retrieve GNSS-based velocities and corresponding cellular Doppler measurements from a plurality of GNSS enabled mobile devices in a coverage area of the cellular base station 120. The received GNSS-based mobile velocities and corresponding cellular Doppler measurements may be utilized to locate the cellular base station 120. In this regard, the received location-stamped GNSS velocities and cellular Doppler measurements may be fitted by the processor 302 to a velocity-Doppler model of

$${f}_{d} = \frac{{\overline{v}}_{r}}{λ} = \frac{\overline{v} cos ( θ )}{λ}$$

over a certain Doppler angle, θ. The fitted location-stamped GNSS velocities and cellular Doppler measurements may be utilized to calculate or determine the location of the cellular base station 120. The processor 302 may store the determined location of the cellular base station 120 into the reference database 304, where it may be shared among a plurality of communication devices.

In various exemplary embodiments of the invention, the location server 300 may be operable to receive locations initially projected or estimated from a plurality of GNSS enabled mobile devices such as the GNSS enabled mobile devices 112-119 for the cellular base station 120. The location server 300 may determine a location for the cellular base station 120 based on the received locations projected or estimated from the plurality of GNSS enabled mobile devices. The determined location for the cellular base station 120 may be stored into the reference database 304, where it may be shared among a plurality of communication devices such as the GNSS enabled mobile devices 112-119 to improve LBS performance.

The processor 302 may store the determined location of the cellular base station 120 into the reference database 304, where it may be shared among a plurality of communication devices such as the GNSS enabled mobile devices 112-119.

The reference database 304 may comprise suitable logic, circuitry, interfaces and/or code that may be operable to store location information of associated communication devices such as the cellular base station 120. The stored location information may be provided to communication devices such as the GNSS enabled mobile devices 112-119 to support LBS applications such as location-based access control. The location database 304 may be operable to manage and update the stored location information when need, aperiodically or periodically.

The memory 306 may comprise suitable logic, circuitry, interfaces and/or code that may be operable to store information such as executable instructions and data that may be utilized by the processor 302 and/or other associated component units such as, for example, the reference database 304. The memory 306 may comprise RAM, ROM, low latency nonvolatile memory such as flash memory and/or other suitable electronic data storage.

In an exemplary operation, the processor 302 may be operable to collect GNSS satellite data through the SRN 150 to build the reference database 304. The processor 302 may track or collect information required for locating a cellular base station such as the cellular base station 120. In this regard, the processor 302 may be operable to receive GNSS-based velocities and corresponding cellular Doppler measurements from a plurality of GNSS enabled mobile devices in a coverage area of the cellular base station 120. The received GNSS-based mobile velocities and corresponding cellular Doppler measurements may be utilized to locate the cellular base station 120. For example, the processor 302 may be configured to fit the received location-stamped GNSS velocities and cellular Doppler measurements to a velocity-Doppler model of

$${f}_{d} = \frac{{\overline{v}}_{r}}{λ} = \frac{\overline{v} cos ( θ )}{λ}$$

over a certain Doppler angle, θ. The processor 302 may be operable to utilize the fitted location-stamped GNSS velocities and cellular Doppler measurements to calculate or determine the location of the cellular base station 120. The processor 302 may store the determined location of the cellular base station 120 into the reference database 304, where it may be shared among a plurality of communication devices such as the GNSS enabled mobile devices 112-119 to improve LBS performance.

The processor 302 may also operable to track or collect locations derived or calculated by the GNSS enabled mobile devices 112-119 for the cellular base station 120. The processor 302 may be operable to determine a location for the cellular base station 120 based on the collected locations. The determined location for the cellular base station 120 may be stored into the reference database 304, where it may be shared among a plurality of communication devices such as the GNSS enabled mobile devices 112-119 to, for example, improve LBS performance.

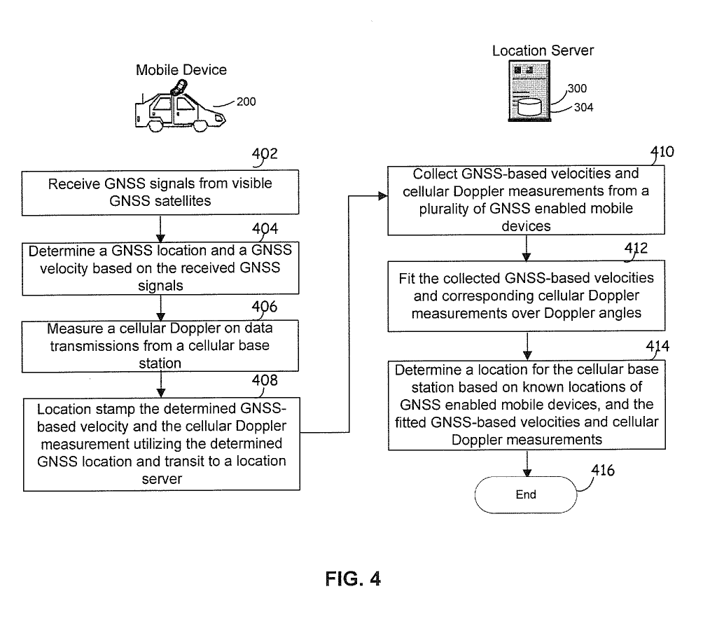

FIG. 4 is a flow chart illustrating an exemplary procedure that is utilized by a location server to determine a location of a cellular base station utilizing GNSS-based velocities and corresponding cellular Doppler measurements, in accordance with an embodiment of the invention. Referring to FIG. 4, the exemplary steps may start with step 402. In step 402, the GNSS enabled mobile device 200 may be operable to receive GNSS signals from visible GNSS satellites such as the GNSS satellites 162-166. In step 404, the GNSS enabled mobile device 200 may be operable to initially determine a GNSS location and a GNSS-based velocity using the received GNSS signals. In step 406, the GNSS enabled mobile device 200 may be operable to measure a cellular Doppler for data transmissions from the cellular base station 120.

In step 408, the cellular measurement and the determined GNSS-based velocity are stamped utilizing the determined GNSS location. In step 410, the location server 300 may be operable to collect GNSS-based velocities and corresponding cellular Doppler measurements from a plurality of GNSS enabled mobile devices. In step 412, the location server 300 may be operable to fit the collected GNSS-based velocities and corresponding cellular Doppler measurements to a velocity-Doppler model of

$${f}_{d} = \frac{{\overline{v}}_{r}}{λ} = \frac{\overline{v} cos ( θ )}{λ}$$

over a certain Doppler angle, θ. In step 414, the location server 300 may be operable to determine or calculate a location for the cellular base station 120 based on known locations of GNSS enabled mobile devices, and the fitted GNSS-based velocities and cellular Doppler measurements. The exemplary steps may end in step 416.

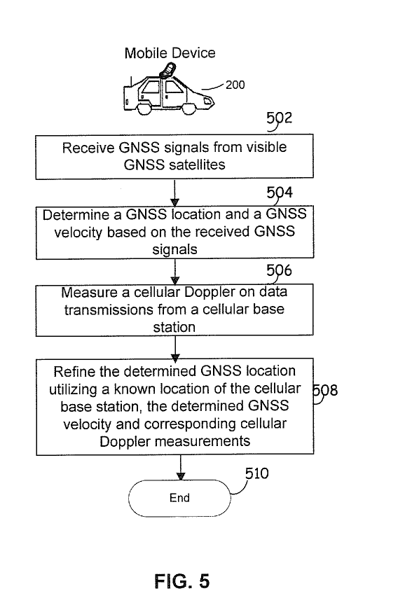

FIG. 5 is a flow chart illustrating an exemplary procedure that is utilized by a GNSS enabled mobile device to refine a GNSS location from a known base station location utilizing GNSS-based velocities and corresponding cellular Doppler measurements, in accordance with an embodiment of the invention. Referring to FIG. 5, the exemplary steps may start with step 502. In step 502, the GNSS enabled mobile device 200 may be operable to receive GNSS signals from visible GNSS satellites such as the GNSS satellites 162-166. In step 504, the GNSS enabled mobile device 200 may be operable to initially determine a GNSS location and a GNSS-based velocity using the received GNSS signals. In step 506, the GNSS enabled mobile device 200 may be operable to measure a cellular Doppler for data transmissions from the cellular base station 120. In step 508, the GNSS enabled mobile device 200 may be operable to acquire a known or determined location for the cellular base station 120 from the location server 300. The acquired location of the cellular base station 120 may be utilized by the GNSS enabled mobile device 200 to refine the determined GNSS location utilizing the determined GNSS velocity and corresponding cellular Doppler measurements. The exemplary steps may end in step 510.

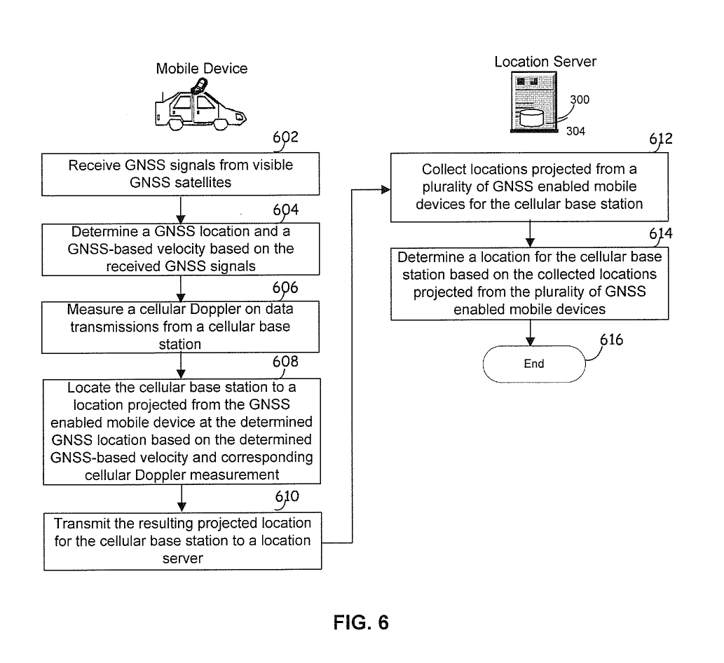

FIG. 6 is a flow chart illustrating an exemplary procedure that is utilized by a GNSS enabled mobile device to locate a cellular base station utilizing GNSS-based velocities and corresponding cellular Doppler measurements, in accordance with an embodiment of the invention. Referring to FIG. 6, the exemplary steps may start with step 602. In step 602, the GNSS enabled mobile device 200 may be operable to receive GNSS signals from visible GNSS satellites such as the GNSS satellites 162-166. In step 604, the GNSS enabled mobile device 200 may be operable to initially determine a GNSS location and a GNSS-based velocity using the received GNSS signals. In step 606, the GNSS enabled mobile device 200 may be operable to measure a cellular Doppler for data transmissions from the cellular base station 120. In step 608, the cellular base station 120 may be located to a location projected or estimated from the GNSS enabled mobile device 200 at the determined GNSS location based on the determined GNSS-based velocity and corresponding cellular Doppler measurement. The GNSS enabled mobile device 200 may determine or calculate the location for the cellular base station 120 by solving the non-linear equations

$${cos}^{- 1} ( \frac{{f}_{d , i} λ}{{\overline{v}}_{i}} ) = {tan}^{- 1} ( \frac{{x}_{i} - {x}_{BS}}{{y}_{i} - {y}_{BS}} ) ,$$

i=1, 2, or

$${cos}^{- 1} ( \frac{( {f}_{d , i} - {f}_{e} ) λ}{{\overline{v}}_{i}} ) = {tan}^{- 1} ( \frac{{x}_{i} - {x}_{BS}}{{y}_{i} - {y}_{BS}} ) ,$$

i=1, 2, 3, where (xᵢ,yᵢ), vᵢ, f_{d,i}, fₑ, λ and (x_{BS},y_{BS}) are mobile location, mobile velocity, cellular Doppler measurement, a frequency offset of the cellular base station 120, wavelength for transmissions from the cellular base station 120, and the location for the cellular base station 120, respectively. In step 610, the GNSS enabled mobile device 200 may be operable to transmit the resulting projected or estimated location for the cellular base station 120 to a location server such as the location server 300. In step 612, the location server 300 may be operable to collect locations projected or estimated from a plurality of GNSS enabled mobile devices for the cellular base station 120. In step 614, the location server 300 may determine a location for the cellular base station 120 based on the collected locations projected or estimated from the plurality of the GNSS enabled mobile devices. The exemplary steps may end in step 616.

In various exemplary aspects of the method and system for determining a location of a cellular base station utilizing mobile GNSS velocity and corresponding cellular Doppler, a GNSS enabled mobile device such as the GNSS enabled mobile device 200 may be operable to concurrently receive GNSS satellite signals via the GNSS receiver 202 from a plurality of GNSS satellites such as the GNSS satellites 162-166, and data transmissions via the cellular transceiver 204 from the cellular base station 120. The GNSS enabled mobile device 200 may utilize the received GNSS signals to determine a GNSS-based velocity and a GNSS location for the GNSS enabled mobile device 200. A cellular Doppler, which corresponds to the determined GNSS-based velocity, may be measured for the received data transmissions from the cellular base station 120. A location of the cellular base station 120 is determined by a remote location server such as the location server 300 based on the determined GNSS-based velocity and the corresponding cellular Doppler measurement. In instances where the cellular base station 120 is located via the location server 300, the GNSS enabled mobile device 200 may location stamp the determined GNSS-based velocity and/or the corresponding cellular Doppler measurement utilizing the determined GNSS location. The resulting location stamped GNSS-based velocity and cellular Doppler measurement may be transmitted to the location server 300 to build the reference database 304. The location server 300 may be configured to receive GNSS velocities and corresponding cellular Doppler measurements from a plurality of GNSS enabled mobile device such as the GNSS enabled mobile device 112-119 in a coverage area of the cellular base station 120. The location server 300 may be operable to fit the received plurality of GNSS velocities and corresponding cellular Doppler measurements to a velocity-Doppler model over various Doppler angles. The location server 300 may determine the location for the cellular base station 120 based on the resulting fitted plurality of GNSS velocities and corresponding cellular Doppler measurements, and locations of the GNSS enabled mobile device 112-119. The determined location of the cellular base station 120 may be stored into the reference database 304, where it may be shared among a plurality of communication devices.

In various exemplary embodiments of the invention, a single mobile device such as the GNSS enabled mobile device 200 at a known location may utilize GNSS-based velocities, corresponding cellular Doppler measurements and its own known GNSS locations to determine location for the cellular base station 120. More specifically, the GNSS enabled mobile device 200 may determine or calculate the location of the cellular base station 120 by solving two or more non-linear equations such as, for example,

$${cos}^{- 1} ( \frac{{f}_{d , i} λ}{{\overline{v}}_{i}} ) = {tan}^{- 1} ( \frac{{x}_{i} - {x}_{BS}}{{y}_{i} - {y}_{BS}} ) ,$$

i=1, 2, or

$${cos}^{- 1} ( \frac{( {f}_{d , i} - {f}_{e} ) λ}{{\overline{v}}_{i}} ) = {tan}^{- 1} ( \frac{{x}_{i} - {x}_{BS}}{{y}_{i} - {y}_{BS}} ) ,$$

i=1, 2, 3, where (xᵢ,yᵢ), vᵢ, f_{d,i}, fₑ, λ and (x_{BS},y_{BS}) are mobile location, mobile velocity, cellular Doppler measurement, a frequency offset of the cellular base station 120, wavelength for transmissions from the cellular base station 120, and the location for the cellular base station 120, respectively. The determined location for the cellular base station 120 may be transmitted or communicated to the location server 140, where it may be utilized to build the reference database 142. The location server 140 may determine a location for the cellular base station 120 based on estimated locations from a plurality GNSS enabled mobile devices for the cellular base station 120. In this regard, the GNSS enabled mobile device 200 may be operable to utilize the determined location for the cellular base station 120 to refine its own GNSS location. The refined GNSS location for the GNSS enabled mobile device 200 may be provided to the location server 300 to refine the reference database 304.

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for determining a location of a cellular base station utilizing mobile GNSS velocity and corresponding cellular Doppler.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for communication, the method comprising:
performing by one or more processors and/or circuits in a Global navigation satellite-based systems (GNSS) enabled mobile device:
concurrently receiving GNSS satellite signals, from a plurality of GNSS satellites, and data transmissions, from a cellular base station;
determining a GNSS-based velocity of said GNSS enabled mobile device and a GNSS location of said GNSS enabled mobile device utilizing said received GNSS satellite signals; and
measuring a cellular Doppler, which corresponds to said determined GNSS-based velocity, of said received data transmissions from said cellular base station, wherein a location for said cellular base station is determined based on said determined GNSS-based velocity and said corresponding cellular Doppler measurement.

2. The method according to claim 1, comprising location stamping said determined GNSS-based velocity and said cellular Doppler measurement utilizing said determined GNSS location.

3. The method according to claim 2, comprising transmitting said location stamped GNSS velocity and said location stamped cellular Doppler measurement to said remote location server, wherein said location server comprises a reference database.

4. The method according to claim 3, wherein said remote location server receives a plurality of GNSS velocities and corresponding cellular Doppler measurements from a plurality of GNSS enabled mobile devices in a coverage area of said cellular base station.

5. The method according to claim 4, wherein said remote location server fits said received plurality of GNSS velocities and corresponding cellular Doppler measurements to a velocity-Doppler model over various Doppler angles.

6. The method according to claim 5, wherein said remote location server determines said location for said cellular base station based on said fitted plurality of GNSS velocities and corresponding cellular Doppler measurements, and locations of said plurality of GNSS enabled mobile devices.

7. The method according to claim 1, comprising determining said location for said cellular base station utilizing said determined GNSS-based velocity, said corresponding cellular Doppler measurement and said determined GNSS location of said GNSS enabled mobile device.

8. The method according to claim 7, comprising determining said location for said cellular base station by simultaneously solving two or more nonlinear equations.

9. The method according to claim 1, comprising refining said GNSS location of said GNSS enabled mobile device utilizing said determined location for said cellular base station.

10. The method according to claim 9, comprising communicating said refined location of said GNSS enabled mobile device to said remote location server.

11. A system for communication, the system comprising:
one or more processors and/or circuits for use in a Global navigation satellite-based systems (GNSS) enabled mobile device, said one or more processors and/or circuits being operable to:
concurrently receive GNSS satellite signals, from a plurality of GNSS satellites, and data transmissions, from a cellular base station;
determine a GNSS-based velocity of said GNSS enabled mobile device and a GNSS location of said GNSS enabled mobile device utilizing said received GNSS satellite signals; and
measure a cellular Doppler, which corresponds to said determined GNSS-based velocity, of said received data transmissions from said cellular base station, wherein a location for said cellular base station is determined based on said determined GNSS-based velocity and said corresponding cellular Doppler measurement.

12. The system according to claim 11, wherein said one or more processors and/or circuits are operable to location stamp said determined GNSS-based velocity and said cellular Doppler measurement utilizing said determined GNSS location.

13. The system according to claim 12, wherein said one or more processors and/or circuits are operable to transmit location stamped GNSS velocity and said location stamped cellular Doppler measurement to said remote location server, wherein said location server comprises a reference database.

14. The system according to claim 13, wherein said remote location server receives a plurality of GNSS velocities and corresponding cellular Doppler measurements from a plurality of GNSS enabled mobile devices in a coverage area of said cellular base station.

15. The system according to claim 14, wherein said remote location server fits said received plurality of GNSS velocities and corresponding cellular Doppler measurements to a velocity-Doppler model over various Doppler angles.

16. The system according to claim 15, wherein said remote location server determines said location for said cellular base station based on said fitted plurality of GNSS velocities and corresponding cellular Doppler measurements, and locations of said plurality of GNSS enabled mobile devices.

17. The system according to claim 11, wherein said one or more processors and/or circuits are operable to determine said location for said cellular base station utilizing said determined GNSS-based velocity, said corresponding cellular Doppler measurement and said determined GNSS location of said GNSS enabled mobile device.

18. The system according to claim 17, wherein said one or more processors and/or circuits are operable to determine said location for said cellular base station by simultaneously solving two or more nonlinear equations.

19. The system according to claim 11, wherein said one or more processors and/or circuits are operable to refine said GNSS location of said GNSS enabled mobile device utilizing said determined location for said cellular base station.

20. The system according to claim 19, wherein said one or more processors and/or circuits are operable to communicate said refined location of said GNSS enabled mobile device to said remote location server.
